(19) United States
(12) Patent Application Publication
(10) Pub. No.: US 2015/0330031 A1
(43) Pub. Date: Nov. 19, 2015

(54) A Railway Sleeper

(71) Applicant: CARBONLOC PTY LTD, Queensland (AU)

(72) Inventor: Gerardus Maria VAN ERP, Toowoomba (AU)

(21) Appl. No.: 14/652,806

(22) PCT Filed: Dec. 19, 2013
(86) PCT No.: PCT/AU2013/001492

§ 371 Date: Jun. 17, 2015

(30) Foreign Application Priority Data
Dec. 19, 2012 (AU) 2012905626

(51) Int. Cl. E01B 3/36; B29C 39/10

(52) U.S. Cl. CPC E01B 3/36; B29C 39/10; B29K 2309/06

(57) ABSTRACT

A railway sleeper comprising a body having a top face on which railway rails are located and a bottom face for placement on a ground surface. The body is formed from a plurality of fibre composite sandwich panels plus a polymer concrete comprising an amount of polymer resin and an amount of filler. Each sandwich panel has a pair of fibre composite skins with a structural core material located therebetween. The fibre composite sandwich panels extend longitudinally within said body.

### FIELD OF THE INVENTION

This invention relates to a railway sleeper. In particular the invention relates to a railway sleeper which may be used as a replacement railway sleeper for timber railway sleepers and therefore will be described in this context. However, it should be appreciated that the railway sleeper may be used for other applications.

Railway sleepers are called ties in some countries so use of the term sleeper in this specification also refers to tie.

### BACKGROUND OF THE INVENTION

Worldwide, the railway industry installs millions of railway sleepers each year. A significant number of these sleepers are used to maintain existing lines while the rest are used to construct new railway lines. The materials traditionally utilised for new railway sleepers are timber, concrete or steel.

Timber railway sleepers generally perform well, but changes in environmental awareness and rapidly diminishing supplies of high quality hardwoods have reduced their long held advantages. Further, the cost of timber railway sleepers is increasing year on year. With millions of timber railway sleepers requiring replacement each year in existing railway lines, there has been difficulty in finding suitable replacement railway sleepers from alternative materials.

Concrete railway sleepers have gained increasing acceptance, but their stiffness typically limits their use to locations where complete sleeper replacement is undertaken or where new track is constructed. Due to their increased depth (approximately 280 mm compared to 120 mm for hardwood timber) concrete sleepers cannot be readily used to replace single sleepers.

Further, this increased depth of the concrete railway sleepers also requires significantly more ballast than timber railway sleepers. Also concrete sleepers have a much higher stiffness than timber railway sleepers, making them unsuitable to replace timber railway sleepers in many applications where some compliance is desired.

The high weight of concrete sleepers (about three to four times that of timber sleepers) makes them expensive to transport and difficult to handle with conventional timber railway sleeper replacement technology.

Steel railway sleepers can be interspersed with timber sleepers but they are generally too light, have poor bearing characteristics, and require high maintenance.

A further difficulty with using steel or concrete to produce replacement timber railway sleepers is that the current fastening systems used for timber cannot be utilised. Accordingly, an alternative fastening system needs to be purchased and stocked as does the associated installation equipment. Also, training in the alternative fastening system needs to be undertaken by railway workers who are used to installing timber railway sleepers.

### OBJECT OF THE INVENTION

It is an object of the invention to overcome or alleviate one or more of the above disadvantages or provide the consumer with a useful or commercial choice. It is the preferred object of this invention to enable railway sleepers to be produced with a similar depth/size as hardwood timber sleepers.

It is a further preferred object of the invention to allow railway sleepers to be produced with similar stiffness characteristics as hardwood timber sleepers.

It is a still further preferred object of the invention to allow railway sleepers to be produced with a weight similar to that of hardwood timber sleepers.

It is a still further preferred object of the invention to allow railway sleepers to be produced cost effectively.

It is a still further preferred object of the invention to allow railway sleepers to be produced that have excellent durability and are able to resist biological and chemical attack.

It is a still further preferred object of the invention to allow railway sleepers to be produced that have no environmental restrictions that affect storage, handling and, eventually, disposal.

### SUMMARY OF THE INVENTION

In one form, although not necessarily the broadest or only form, the invention resides in a railway sleeper comprising a body having a top face on which railway rails are located and a bottom face for placement on a ground surface, said body being formed from:
a polymer concrete comprising an amount of polymer resin and an amount of filler; and
a plurality of fibre composite sandwich panels, each sandwich panel having a pair of fibre composite skins with a structural core material located therebetween;
   wherein the fibre composite sandwich panels extend longitudinally within said body.

Within this patent specification the general term polymer concrete is intended to mean a mixture of aggregate and polymer where the polymer substitutes for the Portland cement used in more conventional concrete.

Preferably said body is moulded and includes two formed rail seats. The rail seats may include a recess to accommodate a foot of one of said railway rails. A raised portion may be located on one or both sides of the recess within the top. The raised portion may include an inclined portion. The inclination of the raised portion may be the same as the inclination of a bottom part of a rail to be located within the recess.

The polymer concrete normally includes an amount of polymer resin and an amount of filler.

The filler in the polymer concrete may include an amount of a light aggregate with a specific gravity less than that of the resin. The filler may include an amount of a heavy aggregate with a specific gravity larger than that of the resin. Polymer concrete used to form the body may include only the light aggregate. Alternatively, the polymer concrete used to form the body may include the light aggregate and the heavy aggregate. Normally, the polymer concrete that is used to form the body is a combination of polymer concrete that solely includes the light aggregate and polymer concrete that includes both the heavy aggregate and the light aggregate.

The polymer concrete in said first portion of the body may have a resin content in the range 25 to 30% by volume. The polymer concrete in the first portion of the body may have a resin content in the range 50 to 60% by volume when no heavy aggregate is used.

The resin in the polymer concrete may be any suitable polyester, vinylester, phenolic, epoxy or polyurethane resin or combination of resins dependent on the desired structural and corrosion resistant properties of the polymer concrete. Preferably, the resin content is from 25 to 30% by volume when heavy aggregate is used and from 50 to 60% when no heavy aggregate is used.

The light aggregate with a specific gravity less than that of the resin can be any type of light aggregate or combination of light aggregates dependent on the desired structural and corrosion resistant properties of the polymer concrete. Usually, the light aggregates have a specific gravity of 0.5 to 0.9. Preferably, the light aggregate has a specific gravity that is close to the specific gravity of the resin. The light aggregates usually make up 20 to 25% by volume of the polymer concrete when heavy aggregate is used and 40 to 50% when no heavy aggregate is used. Preferably, the light aggregate consists at least substantially of cenospheres. The cenospheres normally have a specific gravity of approximately 0.7 and are 20-300 microns in size. Alternately, hollow glass microspheres with a similar specific gravity and volume may be used.

The heavy aggregate with a specific gravity larger than that of the resin can be any type of heavy aggregate or combination of heavy aggregates dependent on the desired structural and corrosion resistant properties of the polymer concrete. The heavy aggregates usually make up 40-60% by volume of the polymer concrete in those portions of said polymer concrete where said heavy aggregate is used.

A first portion of said body may be formed from a first polymer concrete that includes an insignificant amount of the heavy aggregate, and a second portion of said body formed from a second polymer concrete that includes a mixture of the heavy aggregate and the light aggregate.

Said second portion of the body may be an upper portion of the sleeper and said first portion comprise the volume between said sandwich panels.

Preferably the heavy aggregate is crushed hard rock, more preferably crushed basalt. The crushed basalt may have a particle size 5 to 7 mm. Preferably the basalt makes up between 40-50% by volume of the polymer concrete. The basalt normally has a specific gravity of approximately 2.8. Alternately, sand that has a similar specific gravity as basalt may be used. Preferably the sand makes up between 50-60% by volume of the polymer concrete.

Alternatively, the heavy aggregate may be made up of one or more of coloured stones, gravel, limestone, shells, glass or the like material.

Preferably the resin contains a thixotrope to keep the light aggregate in suspension. The amount of thixotrope is normally between 0.5% to 1% of the resin weight. Preferably, the thixotrope is fumed silica such as found in Cabosil or Aerosil.

The polymer concrete of the present invention may also include fibrous reinforcement material to increase the structural properties of the polymer concrete mix. The reinforcement material may be glass, aramid, carbon, timber and/or thermoplastic fibres.

Preferably, the polymer concrete includes a fire resistant compound such as aluminium trihydrate.

The amount of resin in the polymer concrete within a bottom portion of the body is higher when compared to a top portion of the body.

Normally the majority of the sandwich panels are vertically orientated within the body. That is, the panels are aligned so that the panels are substantially perpendicular with respect to the top face and bottom face of the body.

Preferably at least one of the sandwich panels extends substantially the length of the body. More preferably, the majority of the sandwich panels extend for substantially the length of the body.

A sandwich panel may be located directly under each rail seat.

The sandwich panel under each respective rail seats may be aligned so that the sandwich panels are substantially parallel with respect to the top face and the bottom face of the body.

The structural core material of the sandwich panel is typically made from a polymer or is polymer based. The structural core material may include microspheres made from polymeric materials, such epoxy resin, unsaturated polyester resin, silicone resin, phenolics, polyvinyl alcohol, polyvinyl chloride, polypropylene, and polystyrene or from inorganic materials, such as glass, silica-alumina ceramics or cenospheres (hollow fly ash particles).

Alternatively, structural core material may include a foamed phenolic resin product.

The skins of the sandwich panels may be made from a polymer reinforced with fibres. The fibres may be made from glass, carbon, Kevlar, thermoplastics or combinations thereof. The polymer may be made of polyester, vinyl ester, phenolic, epoxy, polyurethane, thermoplastics or combination thereof.

Preferably, the polymer used in the skins is the same as that used in the structural core material. More preferably, the sandwich panel is produced in single manufacturing process. In this way a strong primary bond can be created between the skins and the foam core.

The sleeper may also include at least one fibre composite reinforcement member. The fibre composite member may have similar amounts of fibres orientated in longitudinal and transverse direction.

The fibre composite reinforcement member may be located either above or below the sandwich panels. Normally there are two fibre composite reinforcement members. One fibre composite reinforcement member may be located above the sandwich panels whilst one fibre composite reinforcement member may be located below the sandwich panels. At least one reinforcement sheet of fibre composite material may be located within the sleeper above said sandwich panels, and at least one reinforcement sheet of fibre composite material located within the sleeper below said sandwich panels.

The fibre composite reinforcement member may be oriented so that it is parallel to the top surface and the bottom surface. That is, the fibre composite reinforcement member may be oriented transversely (or perpendicular) to the sandwich panels.

The fibre composite reinforcement member may be produced from any suitable glass, carbon or aramid fibre and/or plastic material. Normally the fibre composite reinforcement member is made of the same materials as used to produce the skin of the sandwich panels. Suitably, the fibre composite reinforcement member is double the thickness of a skin of the sandwich panel. Preferably the fibre composite reinforcement sheets are made of the same material that makes the skins of the sandwich panels. Preferably, each fibre composite reinforcement sheet is made from two skins of a sandwich panel.

In another form, the invention resides in a method of producing a railway sleeper formed from castable material, said method including the steps of:
locating a first amount of polymer concrete in a mould where the bottom of the mould corresponds to the top of the sleeper;
placing a plurality of sandwich panels in a spaced arrangement within the mould; and
filling the spaces between said panels with further polymer concrete.

The method may further include the step of placing fibre composite reinforcement members within the mould.

Preferably in the method said first amount of polymer concrete includes an amount of polymer resin and an amount of filler material where a first proportion of said filler material has a higher specific gravity than the specific gravity of the resin and a second proportion of said filler material has a specific gravity lower than or approximately equal to that the resin; said method including the steps of:
placing the first amount of polymer concrete as a slurry into the mould;
allowing said higher specific gravity filler material to settle while allowing said lower specific gravity filler material to remain relatively evenly suspended in the resin; and
allowing the first amount of polymer concrete to cure.

### BRIEF DESCRIPTION OF THE DRAWINGS

An embodiment of the invention, by way of examples only, will be described with reference to the accompanying drawings in which:

FIG. 1 shows a perspective view of a railway sleeper according to one embodiment of the invention;

FIG. 2A shows a perspective view of the location of sandwich panels and fibre composite members within the sleeper shown in FIG. 1;

FIG. 2B is an end-view enlargement of the circled portion of FIG. 2A;

FIGS. 3A to 9A show front cross-sectional views during the steps taken to manufacture a railway sleeper of the invention in a mould;

FIGS. 3B to 9B show end cross-sectional views during the steps illustrated in corresponding FIGS. 3A to 9A;

FIG. 10 is a perspective view showing attachment of a railway rail to a railway sleeper according to the invention; and

FIG. 11 is a cross-sectional view of a railway rail attached to the sleeper shown in FIG. 10.

### DESCRIPTION OF EMBODIMENTS OF THE INVENTION

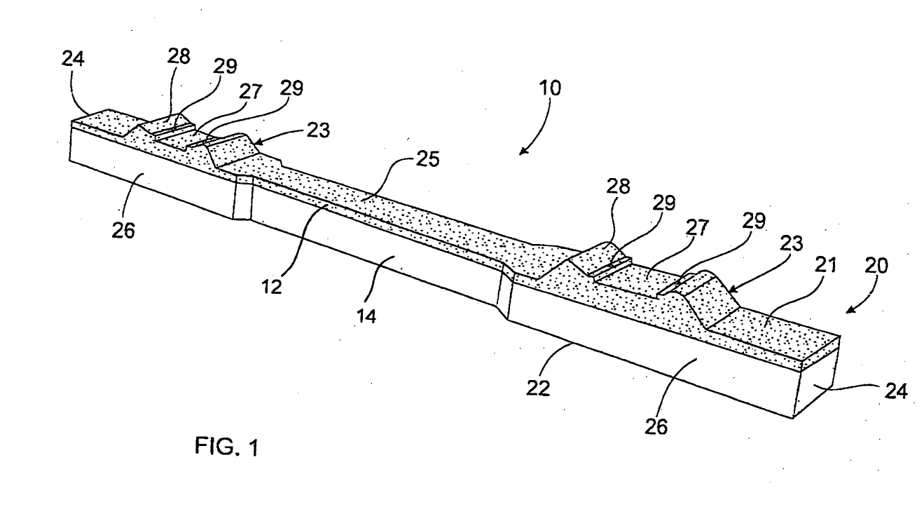

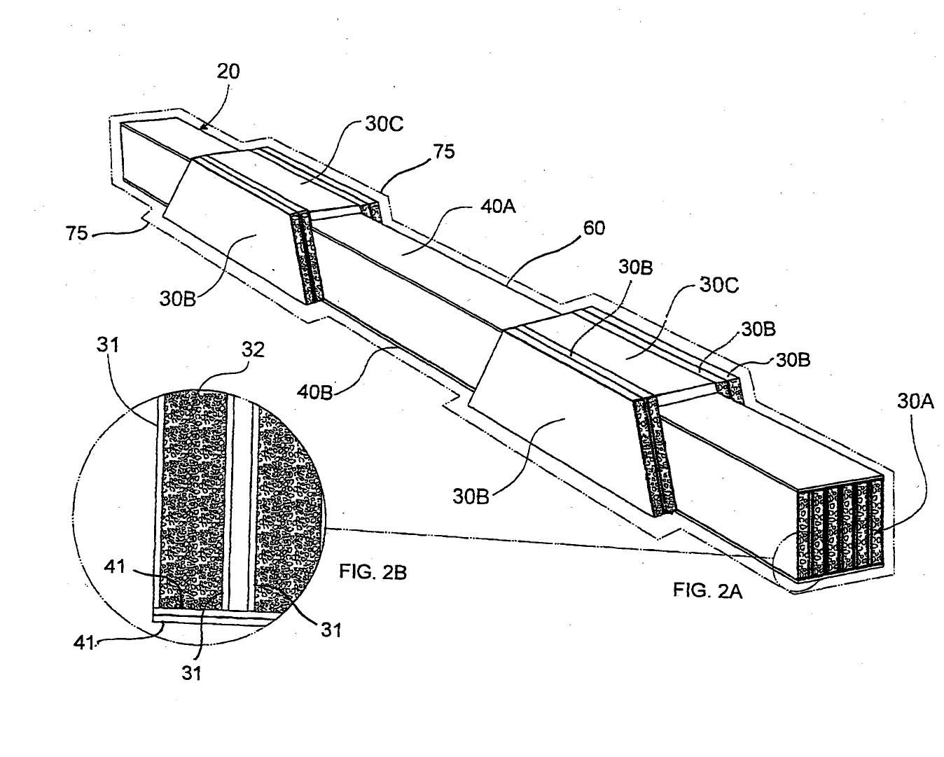

FIGS. 1 and 2 show a railway sleeper 10 that can be used for replacement of a timber sleeper. The sleeper 10 is constructed from a body 20, a series of sandwich panels 30 and two sheet-like fibre composite members 40A and 40B.

The body 20 is constructed from polymer concrete into which is embedded reinforcements. The body has a top face 21 for placement of a railway rail and a bottom face 22 which in use of the railway sleeper. 10 bears onto a bed of ballast, typically coarse graded rock. The railway sleeper 10 has two rail seats 23, two ends 24 and a middle section 25. A pair of wings 26 extend sideways from the body 20 adjacent each rail seat 23. Each rail seat 23 has a recess 27 with two raised portions 28 extending away from the recess 27. A fastening hole 29 is located adjacent each of the raised portions for engagement with a fastener.

The polymer concrete which forms an upper part of the body 20 is formed with approximately 28% by volume of epoxy resin including a fumed silica that is 0.8% of the weight of the resin, 22% by volume of light aggregate and 50% by volume of heavy aggregate.

The light aggregate is in the form of cenospheres having a specific gravity of approximately 0.7. A cenosphere is a lightweight, inert, hollow sphere made largely of silica and alumina and usually filled with air or inert gas, and typically produced as a byproduct of coal combustion at thermal power plants. The heavy aggregate is formed from crushed basalt having a specific gravity of approximately 2.8 and a particle size of 3-5 mm.

The light aggregate has a specific gravity that is slightly less than that of the resin whilst the heavy aggregate has a specific gravity that is larger than that of the resin.

A thixotrope is added to the resin so that the light aggregate will stay in suspension within the resin and hence will be substantially uniformly distributed throughout the polymer concrete. Consequently, the resin together with the light aggregate in suspension becomes a flowable filled resin system in its own right. The amount of the light aggregate suspended in the resin can be varied as required.

The heavy aggregate, which is heavier than the resin, sinks to the bottom of the polymer concrete before it sets and can as such be positioned adjacent a top face of the sleeper especially around the rail seats. By adding the heavier aggregate in specific amounts during the pour, layers or areas of polymer concrete with different amounts of aggregate and hence different density and structural properties can be obtained throughout the sleeper.

The polymer concrete which forms a lower part of the body 20 is formed with approximately 56% by volume of epoxy resin including a fumed silica that is 0.8% of the weight of the resin, 44% by volume of light aggregate That is, the polymer concrete that forms a lower part of the body is the same as the polymer concrete that forms an upper part of the body without the heavy aggregate.

The sandwich panels 30 are located within the body 20 and provide additional shear strength to the sleeper 10. The sandwich panels take three different forms. The main sandwich panels 30A extend the length of the sleeper 10, are vertically oriented and are substantially rectangular in shape. There are six main sandwich panels 30A shown in FIG. 2, but that number can vary as desired. Reinforcement sheets 40A and 40B lay across the top and bottom edges respectively of the main panels 30A and form respective reinforcement members. The main panels 30A and reinforcement sheets 40A and 40B together form the main longitudinal structure 60 of the body 20.

Wing sandwich panels 30B are trapezoid in shape and are located within the wings 26 of the sleeper 10. A pair of wing panels 30B is located on each side of the main longitudinal structure adjacent each rail seat 23. These increase the width of the sleeper at each rail seat and provide additional stiffness to the sleeper directly under the relevant rail.

The sandwich panels 30A and 30B are vertically orientated and accordingly are substantially perpendicular to the top face 21 and bottom face 22 of the body 20. A rectangular sandwich panel is located horizontally directly underneath each rail seat 23 to form a rail seat bed panel 30C and portion of the top surface 21 of the structure 60. The rail seat bed panel 30C may be deleted in some light duty sleepers.

Each sandwich panel 30A, 30B and 30C has a syntactic foam core 32 and two fibre reinforced polymer skins 31. The syntactic foam core 32 in this embodiment is made from phenolic resin with hollow glass microspheres and other liquid fillers such as glycerol and lignosulphonate. It should be appreciated that the materials used to produce the syntactic foam core 32 may be varied to suit the specified need of the railway sleeper. The reinforced polymer skins 31 are made from glass fibre and phenolic resin. However the skins 31 may alternatively be made from other materials depending on the specific needs of the railway sleeper.

Respective fibre composite sheet-like reinforcement members 40A and 40B are located respectively above and below the rectangular main sandwich panels 30A. Each fibre composite reinforcement sheet 40A and 40B is made from two fibre-reinforced polymer skins 41 made from glass fibre and phenolic resin. The skins 41 have the same composition and structure as the skins 31 on the faces of the sandwich panels.

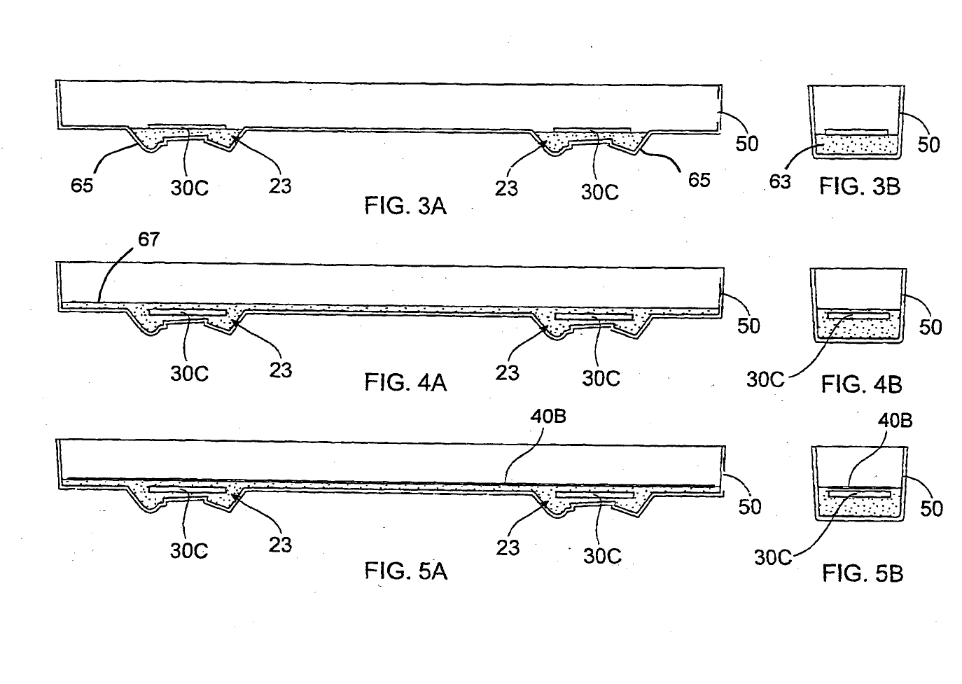

The process of manufacturing the railway sleeper 10 will now be described with reference to the steps shown in FIGS. 3A and 3B to 9A and 9B. The railway sleeper 10 is produced in an upside down manner.

An amount of polymer concrete 63 is first poured into lower cavities 65 in a mould 50. These cavities 65 correspond to the rail seats 23 on the sleeper. The polymer concrete, which includes the heavy aggregate, is mixed and poured into the cavities. The heavy aggregate settles to the bottom of the mould 50. A rail seat bed panel 30C is then placed in a horizontal orientation in position. That stage is illustrated by FIGS. 3A and 3B.

More polymer concrete 67 which includes the heavy aggregate is then poured into the mould 50 as shown in FIGS. 4A and 4B. Once again the heavy aggregate settles to the bottom of the mould.

The upper fibre composite reinforcement sheet 40A is then positioned along substantially the full length of the mould 50 as shown in FIGS. 5A and 5B.

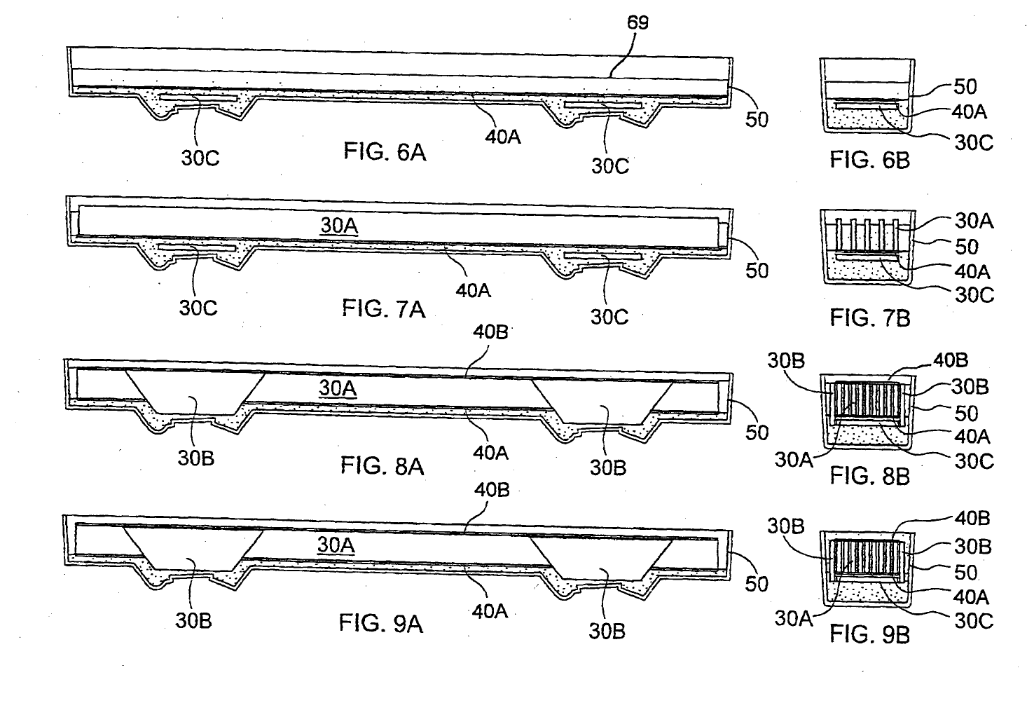

Polymer concrete 69 which does not include the heavy aggregate is then poured into the mould 50 as shown in FIGS. 6A and 61B.

The main sandwich panels 30A, which extend substantially the full length of the mould, are then located within the mould as shown in FIGS. 7A and 7B. These main panels 30A are spaced from each other and from the walls of the mould and are vertically oriented within the mould 50. As the main panels 30A are positioned within the mould, the polymer concrete 69 which does not include the heavy aggregate is forced between the panels 30A.

The wing panels 30B are then added as shown in FIGS. 8A and 8B. Again, these sandwich panels 30B are vertically orientated. More polymer concrete 71 which does not include the heavy aggregate is then added to fully cover the panels 30A and 30B. The lower fibre composite reinforcement sheet 40B is then located along substantially the full length of the mould as also shown in FIGS. 8A and 8B.

More polymer concrete 69 which does not include the heavy aggregate is then added to cover the lower reinforcement sheet 40B and fill the remainder of the mould. The mould is then screeded and the polymer concrete left to cure as shown in FIGS. 9A and 9B.

When removed from the mould all the sandwich panels 30 and reinforcement sheets are covered by a protective layer of polymer concrete. In FIG. 1 the upper portion of the sleeper 12, is shown stippled to indicate the polymer concrete 63 and 67 which contains the heavy aggregate, while the lower portion 14 is shown unshaded to indicate the polymer concrete 69 in which the heavier aggregate is absent.

It should be appreciated that, alternatively, to improve wear characteristic, polymer concrete which includes the heavy aggregate may be used between the sandwich panels 30 and the mould, and also placed on top of the fibre composite reinforcement member located at the top of the mould.

The use of the polymer concrete which includes the heavy aggregate provides additional impact and wear resistance to the body 20 of the sleeper 10. By using a polymer concrete in which the heavy aggregate settles to the bottom in the mould the present invention provides greatly improved compressive and wear resistance to the upper portion of the sleeper while also providing improved tensile strength to the lower portion of the sleeper. The process uses gravity alone to provide the segregation of the aggregates.

Once the railway sleeper has cured, holes 29 are drilled through the rail seat and the upper reinforcement sheet under the rail seat. The holes allow standard railway screw fasteners to be used to fasten a rail 5 to the sleeper. Alternatively the holes 29 can be drilled on site during installation of the sleepers. Dog spike fasteners can be used instead of screw fasteners.

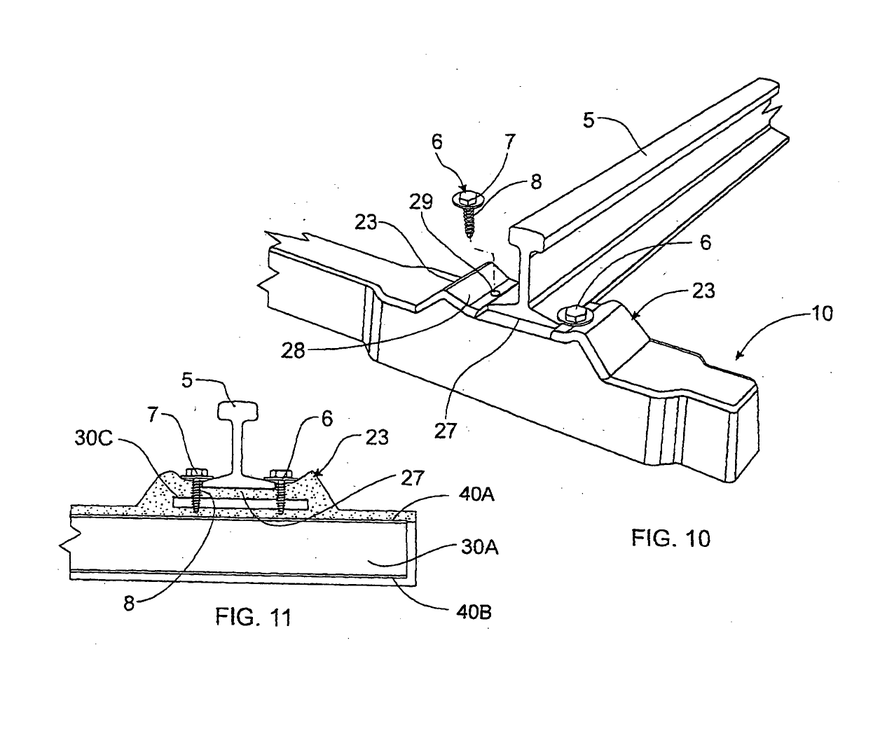

In order to attach railway rails to the railway sleeper 10, as shown in FIGS. 10 and 11, a rail fastening screw 6 is located through the predrilled holes 29. The screw 6 is rotated until its wide-collared head 7 engages with both the rail 5 and the raised portion 28 of the rail seat 23. The raised portion 28 of the rail seat better locates against the sloping underside of the screw's collar and assists in preventing bending of the head 7 with respect to the screw's shaft 8. The threaded shaft 8 of the screw 6 is able to engage a rail seat panel 30C the upper reinforcement sheet 40A and the relevant main panels 30A.

It should be appreciated that the sleeper may alternatively have a flat rail seat so that traditional fastening systems that are used on hardwood timber sleepers can be utilised.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A railway sleeper comprising a body having a top face on which railway rails are located and a bottom face for placement on a ground surface, said body being formed from:
a polymer concrete comprising an amount of polymer resin and an amount of filler; and
a plurality of fibre composite sandwich panels, each sandwich panel having a pair of fibre composite skins with a structural core material located therebetween;
wherein the fibre composite sandwich panels extend longitudinally within said body.

2. A sleeper according to claim 1 wherein said body is moulded and includes two integrally moulded rail seats.

3. A sleeper according to claim 2 wherein each said rail seat includes a recess to accommodate a foot of one of said railway rails.

4. A sleeper according to claim 2 wherein a said sandwich panel is located directly under each rail seat.

5. A sleeper according to claim 4 wherein each said sandwich panel under its respective rail seat is aligned so it is substantially parallel with respect to said top face and said bottom face of the body.

6. (canceled)

7. (canceled)

8. A sleeper according to claim 5 wherein the filler comprises a heavy aggregate with a specific gravity greater than that of the resin.

9. A sleeper according to claim 8 wherein:
a first portion of said body is formed from a first polymer concrete that includes an insignificant amount of the heavy aggregate, and
a second portion of said body is formed from a second polymer concrete that includes a mixture of the heavy aggregate and the light aggregate.

10. A sleeper according to claim 9 wherein said second portion of the body is an upper portion of the sleeper and said first portion comprises the volume between said sandwich panels.

11. A railway sleeper according to claim 3 wherein the majority of the sandwich panels are orientated vertically within the body.

12. (canceled)

13. A railway sleeper according to claim 3 wherein the majority of the sandwich panels extend for substantially the length of the body.

14. A sleeper according to claim 3 wherein a raised portion is located on one or both sides of the recess within the top.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A sleeper according to claim 10 wherein the proportion of resin in the polymer concrete of said upper second portion of the body is lower than the proportion in said first portion of the body.

27. A sleeper according to claim 1 wherein said structural core material of the sandwich panels is polymer based.

28. (canceled)

29. (canceled)

30. A sleeper according to claim 1 wherein the skins of said sandwich panels are made of a polymer reinforced with fibres made from glass, carbon, Kevlar, thermoplastics or combinations thereof.

31. A sleeper according to claim 1 also including at least one reinforcement sheet of fibre composite material located within the sleeper above and below said sandwich panels.

32. A sleeper according to claim 31 wherein the fibre composite reinforcement sheets are made of the same material used to produce the skin of the sandwich panels.

33. A sleeper according to claim 32 wherein the fibre composite reinforcement sheets are made from two skins as used for a sandwich panel.

34. A method of producing a railway sleeper formed from castable material, said method including the steps of:
locating a first amount of polymer concrete in a mould where the bottom of the mould corresponds to the top of the sleeper;
placing a plurality of sandwich panels in a spaced arrangement within the mould; and
filling the spaces between said panels with further polymer concrete.

35. A method according to claim 34 including the step of placing fibre composite reinforcement sheets within the mould.

36. A method according to claim 34 wherein said first amount of polymer concrete includes an amount of polymer resin and an amount of filler material where a first proportion of said filler material has a higher specific gravity than the specific gravity of the resin and a second proportion of said filler material has a specific gravity lower than or approximately equal to that the resin; said method including the steps of:
placing the first amount of polymer concrete as a slurry into the mould;
allowing said higher specific gravity filler material to settle while allowing said lower specific gravity filler material to remain relatively evenly suspended in the resin; and
allowing the first amount of polymer concrete to cure.
